(19) United States
(12) Patent Application Publication
(10) Pub. No.: US 2014/0307143 A1
(43) Pub. Date: Oct. 16, 2014

(54) APPARATUS AND METHOD FOR SHOOTING VIDEO IN TERMINAL

(71) Applicant: SAMSUNG ELECTRONICS CO. LTD., SUWON-SI (KR)

(72) Inventors: Sung-Ho SON, Daegu (KR); Sun-Min HWANG, Hwaseong-si (KR)

(73) Assignee: SAMSUNG ELECTRONICS CO. LTD., SUWON-SI (KR)

(21) Appl. No.: 14/021,236

(22) Filed: Sep. 9, 2013

(30) Foreign Application Priority Data
Apr. 12, 2013 (KR) 10-2013-0040384

(51) Int. Cl. H04N 5/232

(52) U.S. Cl. CPC H04N 5/23293
USPC 348/333.01

(57) ABSTRACT

An apparatus for shooting video in a terminal is provided. The apparatus includes a display configured to sequentially display, on a video shooting progress bar, a plurality of indications indicating a plurality of associated sharing applications capable of sharing content based on a video size supported by each of the plurality of sharing applications, in a video shooting mode, and a controller configured to display a change in a video size corresponding to video shooting time on the video shooting progress bar in the video shooting mode, thereby controlling the display to sequentially display types of sharing applications capable of supporting the video size changed during video shooting.

### CROSS-REFERENCE TO RELATED APPLICATION(S)

This application claims the benefit under 35 U.S.C. §119(a) of a Korean patent application filed on Apr. 12, 2013 in the Korean Intellectual Property Office and assigned Serial No. 10-2013-0040384, the entire disclosure of which is hereby incorporated by reference.

### TECHNICAL FIELD

The present disclosure relates to an apparatus and method for shooting video in a terminal. More particularly, the present disclosure relates to a video shooting apparatus and method for allowing a user to shoot video complying with his/her intention in accordance with a guide provided during video shooting in a terminal

### BACKGROUND

With the help of applications capable of sharing content, such as Multimedia Messaging Service (MMS), e-mail, Messenger™, YouTube™, social network services and cloud services, users may send or share multimedia content such as photos and videos.

Generally, the sharing applications are different from each other in supportable video size. In most cases, the size supported by the sharing applications may be smaller than the size of the shot video.

In order to send or share video using a specific sharing application, a user may first shoot video and then attempt to send or share the shot video using the specific sharing application. If the size of the shot video is greater than the video size supported by the specific sharing application, the specific sharing application may fail in video sending or sharing, so the user needs to re-shoot the video or resize the shot video.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a video shooting apparatus and method for allowing a user to shoot video complying with the user intention in accordance with a guide provided during video shooting in a terminal.

Another aspect of the present disclosure is to provide a video shooting apparatus and method capable of sequentially displaying supportable sharing applications based on the size of shot video during video shooting in a terminal.

Further another aspect of the present disclosure is to provide a video shooting apparatus and method capable of storing videos for supportable sharing applications based on the size of shot video during video shooting in a terminal.

In accordance with an aspect of the present disclosure, an apparatus for shooting video in a terminal is provided. The apparatus includes a display configured to sequentially display, on a video shooting progress bar, a plurality of indications indicating a plurality of associated sharing applications capable of sharing content based on a video size supported by each of the plurality of sharing applications, in a video shooting mode, and a controller configured to display a change in a video size corresponding to video shooting time on the video shooting progress bar in the video shooting mode, thereby controlling the display to sequentially display types of sharing applications capable of supporting the video size changed during video shooting.

In accordance with an aspect of the present disclosure, a method for shooting video in a terminal is provided. The method includes sequentially displaying on a video shooting progress bar a plurality of indications indicating a plurality of associated sharing applications capable of sharing content based on a video size supported by each of the plurality of sharing applications, in a video shooting mode, and displaying a change in a video size corresponding to video shooting time in the video shooting mode, thereby sequentially displaying types of sharing applications capable of supporting the video size changed during video shooting.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a block diagram of a terminal according to various embodiments of the present disclosure;

FIGS. 2A to 2D illustrate a video shooting operation in a terminal according to a first embodiment of the present disclosure;

FIG. 3 is a flowchart illustrating a video shooting process in a terminal according to the first embodiment of the present disclosure;

FIG. 4 illustrates a video shooting operation in a terminal according to a second embodiment of the present disclosure;

FIG. 5 is a flowchart illustrating a video shooting process in a terminal according to the second embodiment of the present disclosure;

FIG. 6 illustrates a video shooting operation in a terminal according to a third embodiment of the present disclosure;

FIGS. 7A and 7B are flowcharts illustrating a video shooting process in a terminal according to the third embodiment of the present disclosure;

FIGS. 8A and 8B illustrate a video shooting operation in a terminal according to a fourth embodiment of the present disclosure;

FIGS. 9A and 9B are flowcharts illustrating a video shooting process in a terminal according to the fourth embodiment of the present disclosure;

FIGS. 10A and 10B illustrate a video shooting operation in a terminal according to a fifth embodiment of the present disclosure;

FIGS. 11A and 11B are flowcharts illustrating a video shooting process in a terminal according to the fifth embodiment of the present disclosure;

FIGS. 12A and 12B illustrate a video shooting operation in a terminal according to a sixth embodiment of the present disclosure; and

FIG. 13 is a flowchart illustrating a video shooting process in a terminal according to a seventh embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skilled in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terminals, to which various embodiments of the present disclosure are applicable, may include mobile terminals and fixed terminals. The mobile terminals, easy-to-carry portable electronic devices, may include video phones, cellular phones, smart phones, Wideband Code Division Multiple Access (WCDMA) terminals, Universal Mobile Telecommunication Service (UMTS) terminals, Personal Digital Assistants (PDAs), Portable Multimedia Players (PMPs), Digital Multimedia Broadcasting (DMB) terminals, Electronic-Book (E-Book) readers, portable computers (for example, laptop computers, tablet computers and the like), digital camera and the like. The fixed terminals may include desktop Personal Computers (PCs) and the like.

The term ‘sharing application capable of sharing content’ as used herein may refer to applications capable of sending or sharing video, such as Multimedia Messaging Service (MMS), e-mail, Messenger™, YouTube™, social network services and cloud services, that users may send or share multimedia content such as photos and videos.

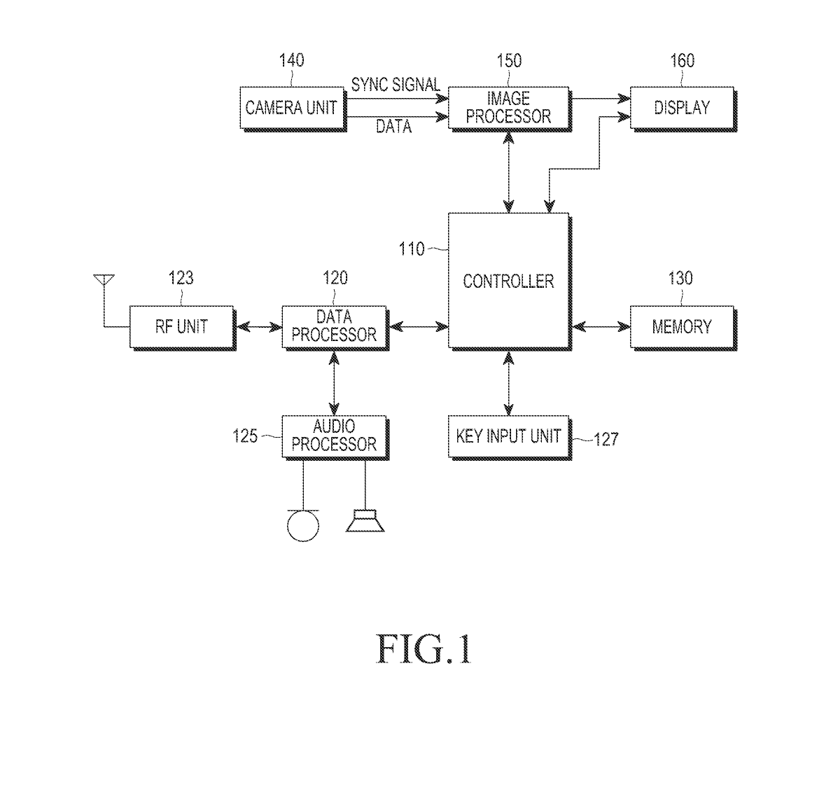

FIG. 1 illustrates a block diagram of a terminal according to various embodiments of the present disclosure.

Referring to FIG. 1, a Radio Frequency (RF) unit 123 is responsible for wireless communication of the terminal. The RF unit 123 includes an RF transmitter for up-converting a frequency of transmission signals and amplifying the up-converted transmission signals and an RF receiver for Low-Noise-Amplifying (LNA) received signals and down-converting a frequency of the received LNA-amplified signal. A data processor 120 includes a transmitter for coding and modulating the transmission signals and a receiver for demodulating and decoding the received signals. In other words, the data processor 120 may be comprised of a modulator-demodulator (modem) and a coder-decoder (codec). The codec may include a data codec for processing packet data and the like, and an audio codec for processing audio signals such as voice. An audio processor 125 plays received audio signals output from the audio codec in the data processor 120, using a speaker, and transfers transmission audio signals picked up by a microphone to the audio codec in the data processor 120.

A key input unit 127 includes character/numeric keys for entering character and numeric information and function keys for setting various functions.

A memory 130 may be comprised of a program memory and a data memory. The program memory may store programs for controlling the overall operation of the terminal. In accordance with various embodiments of the present disclosure, the program memory may store a control program for displaying types of supportable sharing applications based on the video size during video shooting and storing videos for supportable sharing applications on the video size during video shooting. The data memory may temporarily store the data generated during execution of the control program.

In accordance with various embodiments of the present disclosure, the memory 130 includes folders which are classified according to the type of sharing applications. In the folders are stored video files which are created for their associated sharing applications.

The memory 130 may store video files including indications that indicate their associated sharing applications.

A controller 110 controls the overall operation of the terminal.

In accordance with a first various embodiment of the present disclosure, the controller 110 displays a video shooting progress bar in a predetermined area of a display 160 for displaying video that is being shot in a video shooting mode and sequentially displays a plurality of indications (e.g., markers) indicating a plurality of associated sharing applications capable of sharing content, on the video shooting progress bar based on the video size supported by each of the plurality of sharing applications.

The controller 110 may display a change in video size corresponding to video shooting time on the video shooting progress bar, thereby sequentially displaying types of sharing applications capable of supporting the changed video size during video shooting.

After the video shooting is ended, if there is a sharing application supporting the video size at the time the video shooting is ended, among the plurality of sharing applications corresponding to the plurality of indications displayed on the video shooting progress bar, the controller 110 stores the video that has been shot to the time the video shooting is ended as a video for the sharing application.

In accordance with a second embodiment of the present disclosure, while displaying a change in video size corresponding to video shooting time on the video shooting progress bar in the video shooting mode, the controller 110 sequentially stores a plurality of videos for the plurality of associated sharing applications corresponding to the plurality of indications, which are displayed on the video shooting progress bar based on the change in video size.

In accordance with a third embodiment of the present disclosure, if a specific indication is selected while displaying a change in video size corresponding to video shooting time on the video shooting progress bar in the video shooting mode, the controller 110 checks whether the video size matches with a video size supported by a sharing application corresponding to the specific indication. If the video size matches with the video size supported by the sharing application corresponding to the specific indication, the controller 110 stores the video that has been shot to the time the video sizes match each other since the beginning of the video, as video for the sharing application corresponding to the specific indication.

In accordance with a fourth embodiment of the present disclosure, the controller 110 checks a size of video being shot, while displaying a change in video size corresponding to video shooting time on the video shooting progress bar in the video shooting mode. If the checked size of the video matches with a video size supported by the specific sharing application, the controller 110 stores the video that has been shot to the time the video sizes match each other since the beginning of the video, as video for a first indication among the plurality of same indications, which are substantially similar in appearance and are generally equivalent. The controller 110 newly checks a video size since the storage of the video for the first indication, and determines whether the newly checked video size matches with a video size supported by the specific sharing application. If the newly checked video size matches with the video size supported by the specific sharing application, the controller 110 stores the video that has been shot to the time the video sizes match each other since the beginning of the video whose size is newly checked, as video for an indication located behind the first indication. After storing the video for the indication located behind the first indication, the controller 110 stores a plurality of videos corresponding to the specific sharing application while checking a video size.

In accordance with a fifth various embodiment of the present disclosure, if a specific indication among a plurality of same indications is selected while displaying a change in video size corresponding to video shooting time on the video shooting progress bar in the video shooting mode, the controller 110 determines whether there is at least one indication that is located ahead of the specific indication on the video shooting progress bar. If there is at least one indication that is located ahead of the specific indication on the video shooting progress bar, the controller 110 checks a size of the video being shot, and determines whether the checked size of the video matches with a video size supported by the specific sharing application. If the checked size of the video matches with the video size supported by the specific sharing application, the controller 110 stores the video that has been shot to the time the video sizes match each other since the beginning of the video, as video for the at least one indication. After storing the video for the at least one indication, the controller 110 checks a second video size. If the second video size matches with a video size supported by the specific sharing application, the controller 110 stores the video that has been shot to the time the video sizes match each other since the beginning of the video whose size is newly checked as a video for the specific indication. The controller 110 synthesizes the video for the at least one indication with the video for the specific indication, reduces a resolution of the synthesized video, and generates the resolution-reduced video as one video for the specific indication.

If a plurality of indications are located ahead of the specific indication on the video shooting progress bar, the controller 110 determines whether the checked size of the video matches with a video size supported by the specific sharing application. If the checked size of the video matches with the video size supported by the specific sharing application, the controller 110 stores the video that has been shot to the time the video sizes match each other since the beginning of the video, as video for a first indication among the plurality of indications. The controller 110 checks a second video size since the storage of the video for the first indication. If the second checked video size matches with a video size supported by the specific sharing application, the controller 110 stores the video that has been shot to the time the video sizes match each other since the beginning of the second checked video as a video for an indication located behind the first indication. After storing the video for the indication located behind the first indication on the video shooting progress bar, the controller 110 stores a plurality of videos for the plurality of indications located ahead of the specific indication, while continuing checking a video size.

In accordance with a sixth embodiment of the present disclosure, if a position of a specific indication among the plurality of indications is adjusted on the video shooting progress bar while displaying a change in video size corresponding to video shooting time on the video shooting progress bar in the video shooting mode, the controller 110 changes a storage period of the video for a sharing application corresponding to the specific indication.

In accordance with a seventh embodiment of the present disclosure, the controller 110 sets a video size supported by each of the plurality of sharing applications as a video size changed by a user in a video size change mode for a sharing application. In the video shooting mode, the controller 110 may sequentially display, on the video shooting progress bar, a plurality of indications indicating a plurality of associated sharing applications capable of sharing content based on the video size, which is changed by the user for each of the plurality of sharing applications.

In accordance with various embodiments of the present disclosure, if a ‘view video’ option is selected, the controller 110 displays a video file stored in a folder that is classified according to the type of the sharing application or displays an indication indicating the sharing application of the video file.

A camera unit 140 includes a camera sensor for capturing image data and converting the captured optical image signal into an electrical image signal and a signal processor for converting the analog image signal captured by the camera sensor into digital image data. The camera sensor may be implemented by a Charge-Coupled Device (CCD) or Complementary Metal-Oxide Semiconductor (CMOS) sensor and the signal processor may be implemented with a Digital Signal Processor (DSP). The camera sensor and the signal processor may be implemented either integrally or separately.

An image processor 150 performs Image Signal Processing (ISP) to display the image signals output from the camera unit 140 on the display 160. The ISP includes gamma correction, interpolation, spatial variation, image effects, image scaling, Automatic White Balance (AWB), Automatic Exposure (AE), Automatic Focus (AF) and the like. The image processor 150 processes the image signals output from the camera unit 140 on a frame basis, and outputs the frame image data according to the characteristics and size of the display 160. The image processor 150, which includes a video codec, compresses the frame image data and decompresses the compressed frame image data into its original frame image data using a predetermined coding/decoding scheme. The video codec may include a Joint Photographic Experts Group (JPEG) codec, a Moving Picture Experts Group 4 (MPEG4) codec, a Wavelet codec and the like. The image processor 150 may include an On-Screen Display (OSD) function, and may output OSD data based on the size of the display screen, under control of the controller 110.

The display 160 displays, on its screen, the image signals output from the image processor 150 and the user data output from the controller 110. The display 160 may be comprised of a Liquid Crystal Display (LCD) or any other suitable display. In this case, the display 160 may include an LCD controller, a video memory for storing video data, and an LCD panel. If implemented in a touch screen fashion, the LCD may serve as an input unit. In this case, the display 160 may display the same keys as those on the key input unit 127.

If the display 160 is used as a touch screen unit as it is implemented in a touch screen fashion, the touch screen unit is comprised of a Touch Screen Panel (TSP) including a plurality of sensor panels. The plurality of sensor panels may include a capacitive sensor panel capable of sensing a finger touch and an electromagnetic induction sensor panel capable of sensing a fine touch such as a touch by a stylus pen.

In accordance with various embodiments of the present disclosure, the display 160 may display a video shooting progress bar in a predetermined area thereof in a video shooting mode, and sequentially display, on the video shooting progress bar, a plurality of indications indicating a plurality of associated sharing applications that are capable of sharing content based on the video size supported by each of the plurality of sharing applications.

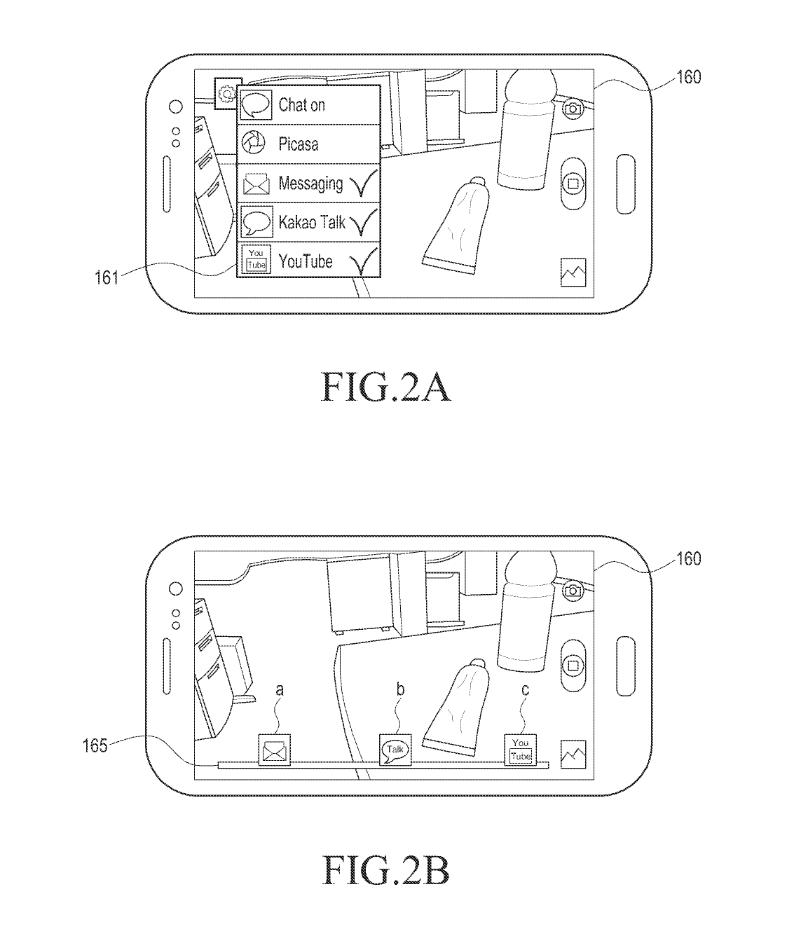

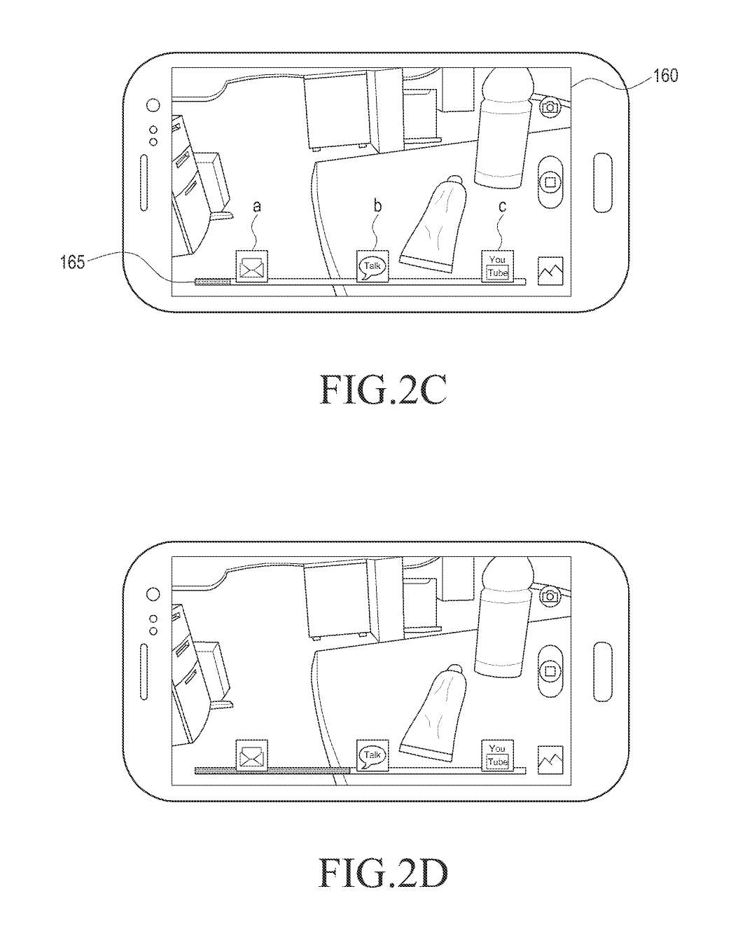

Video shooting operations in the above-described terminal will be described in detail with reference to FIGS. 2 to 12B. Although the indications indicating that are sharing applications capable of sharing content during video shooting in a video shooting mode will be assumed herein to be icons in embodiments of the present disclosure, it will be apparent to those of ordinary skill in the art that the indications indicating kinds of sharing applications may include all other possible indication means capable of indicating any suitable sharing application.

FIGS. 2A to 2D illustrate a video shooting operation in a terminal according to a first embodiment of the present disclosure.

Referring to FIG. 2A, a preview mode illustrates the types of sharing applications that are displayed upon a user's selection. If a ‘shoot video’ option is selected after sharing applications (for example, Messaging, KaKao Talk™ and YouTube™), which can be displayed in a video shooting mode among the types 161 of the sharing applications are selected by the user, the terminal switches to the video shooting mode as illustrated in FIG. 2B.

Referring to FIG. 2B, a video shooting progress bar 165 is displayed in a predetermined area (for example, a lower area) of the display 160 during video shooting in the video shooting mode. A plurality of icons (or indications) ‘a’, ‘b’ and ‘c’ indicating their associated sharing applications (for example, Messaging, KaKao Talk™ and YouTube™), where were previously selected by the user in FIG. 2A, are sequentially displayed on the video shooting progress bar 165 based on the video size (for example, in order of video size) supported by each selected sharing application.

Referring to FIGS. 2C and 2D, as the video shooting is performed, a change in video size corresponding to video shooting time is displayed on the video shooting progress bar 165. Therefore, while the video shooting is performed, the user may determine which sharing application the video presently being shot can be supported. By ending the video shooting when the indication of the change in video size corresponding to video shooting time arrives at the location of an icon indicating the desired sharing application on the video shooting progress bar 165, the user may directly generate the video having the video size supported by the desired sharing application.

Although it is assumed in FIGS. 2A to 2D that the icons corresponding to sharing applications, which are displayed on the video shooting progress bar 165, are selected by the user by way of example, the icons corresponding to a predetermined number of sharing applications frequently used by the user may be automatically displayed.

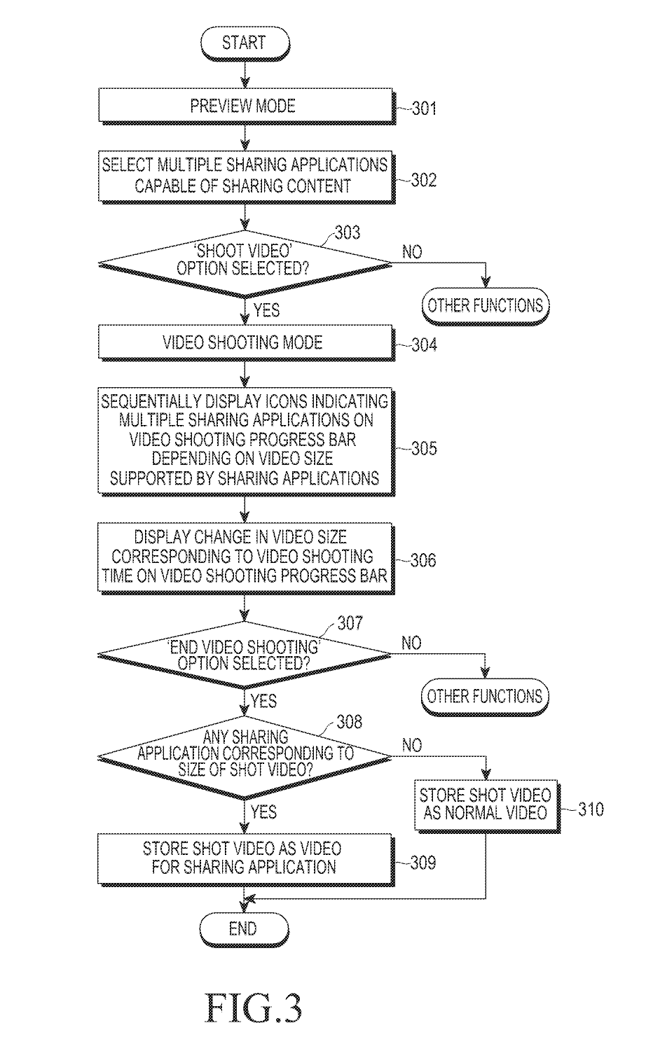

The operation in FIGS. 2A to 2D will be described in detail with reference to FIG. 3.

FIG. 3 is a flowchart illustrating a video shooting process in a terminal according to the first embodiment of the present disclosure.

This video shooting process will be described in detail with reference to FIG. 1 and FIG. 3.

Referring to FIG. 3, at operation 301, if a ‘view types of sharing applications’ option is selected in a preview mode, the controller 110 displays the types of sharing applications. If a ‘shoot video’ option is selected after a one or more sharing applications are selected at operation 302 while displaying the types of sharing applications, the controller 110 detects the selection of the ‘shoot video’ option at operation 303 and switches to the video shooting mode for video shooting at operation 304.

At operation 305, the controller 110 displays a video shooting progress bar in a predetermined area of the display 160 while shooting video on the display 160 in the video shooting mode.

At operation 305, the controller 110 displays, on the video shooting progress bar, a plurality of icons indicating the plurality of sharing applications, which are selected by the user at operation 302, checks the video size supported by each of the plurality of sharing applications, and arranges and displays the plurality of icons at predetermined intervals (for example, in order of video size).

At operation 306, as the video shooting is performed, the controller 110 displays a change in size of the video being shot, which corresponds to video shooting time, on the video shooting progress bar.

If an ‘end video shooting’ option is selected during video shooting, the controller 110 detects the selection of the ‘end video shooting’ option at operation 307 and determines whether there is a specific sharing application supporting the video size corresponding to the period from the beginning of the video until the time that the video shooting ends.

If there is a specific sharing application that supports the video size corresponding to the period from the beginning of the video until the time that the video shooting ends, the controller 110 detects the presence of the specific sharing application at operation 308 and stores the video in the memory 130 as a video for the specific sharing application at operation 309.

On the other hand, referring back to operation 308, if there is no specific sharing application supporting the video size, the controller 110 detects the absence of the specific sharing application in step 308 and stores the video in the memory 130 as normal video at operation 310.

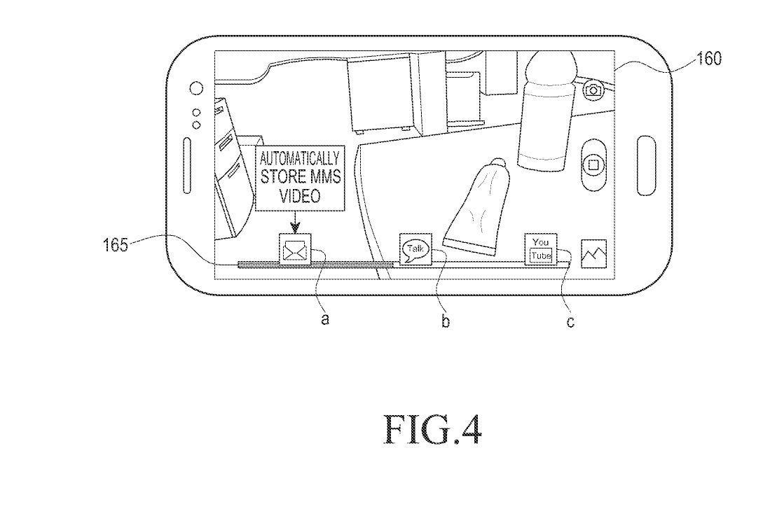

FIG. 4 illustrates a video shooting operation in a terminal according to the second embodiment of the present disclosure.

If an ‘automatic storage for each sharing application’ option is set while a plurality of icons ‘a’, ‘b’ and ‘c’ indicating their associated sharing applications (for example, Messaging, KaKao Talk™ and YouTube™) selected by the user are displayed in a predetermined area (for example, a lower area) of the display 160 in the video shooting mode during video shooting, a plurality of videos for the plurality of sharing applications (for example, Messaging, KaKao Talk™ and YouTube™) corresponding to the plurality of associated icons ‘a’, ‘b’ and ‘c’ may be automatically stored, as illustrated in FIG. 4.

Referring to FIG. 4, a change in video size corresponding to a video shooting time is displayed on the video shooting progress bar 165 during video shooting in the video shooting mode. If an indication of the change in size of the shot video arrives at the icon ‘a’ indicating a ‘Messaging’ sharing application, the video that has been shot to the arrival time at the icon ‘a’ since the beginning of the video shooting is automatically stored as video for the ‘Messaging’ sharing application, and an indication indicating the automatic storage of the video for the ‘Messaging’ sharing application is displayed.

After the video for the ‘Messaging’ sharing application is automatically stored, if the indication of the change in video size corresponding to video shooting time arrives at the icon ‘b’ indicating a ‘KaKao Talk™’ sharing application that is arranged second on the video shooting progress bar 165, the video that has been shot to the time at the icon ‘b’ since the beginning of the video shooting is automatically stored as video for the ‘KaKao Talk™’ sharing application and an indication indicating the automatic storage of the video for the ‘KaKao Talk™’ sharing application is displayed.

After the video for the ‘KaKao Talk™’ sharing application is automatically stored, if the indication of the change in video size corresponding to video shooting time arrives at the icon ‘c’ indicating a ‘YouTube™’ sharing application on the video shooting progress bar 165, the video that has been shot to the arrival time at the icon ‘c’ since the beginning of the video shooting is automatically stored as video for the ‘YouTube™’ sharing application, and an indication indicating the automatic storage of the video for the ‘YouTube™’ sharing application is displayed.

If a plurality of sharing applications are specified by the user during the video shooting, a plurality of videos having different video sizes supported by the corresponding plurality of sharing applications may be automatically generated.

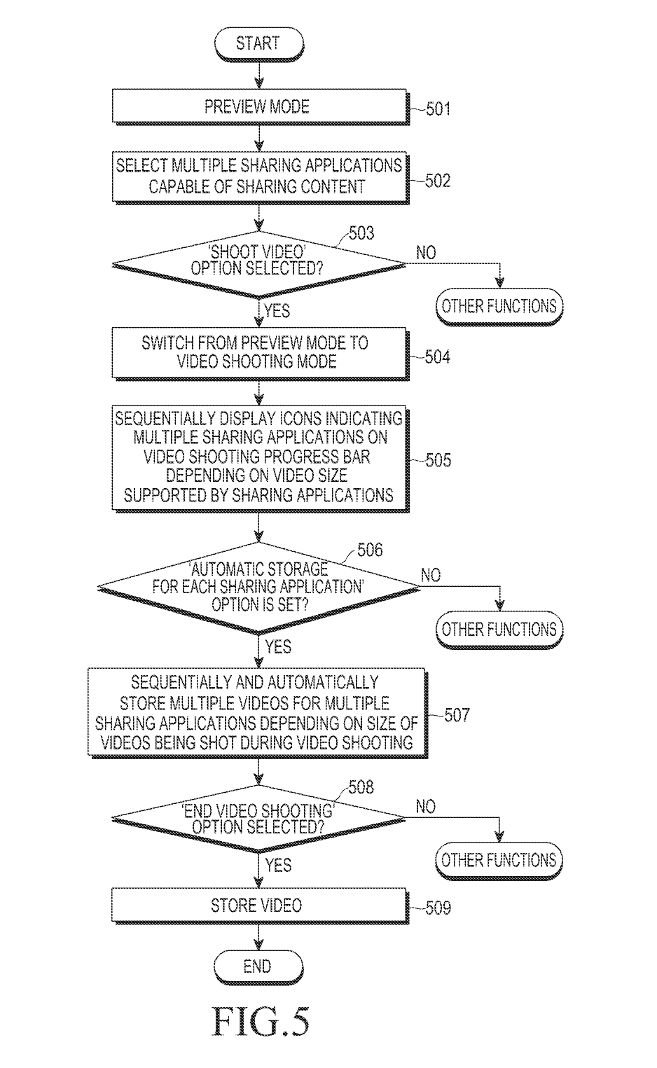

The operation in FIG. 4 will be described in detail below with reference to FIG. 5.

FIG. 5 is a flowchart illustrating a video shooting process in a terminal according to the second embodiment of the present disclosure.

This video shooting process will be described in detail with reference to FIGS. 1 and 5.

Referring to FIG. 5, at operation 501, if a ‘view types of sharing applications’ option is selected in a preview mode, the controller 110 displays the types of sharing applications. If a ‘shoot video’ option is selected after a predetermined number of sharing applications are selected at operation 502 while displaying the types of sharing applications, the controller 110 detects the selection of the ‘shoot video’ option at operation 503 and switches to the video shooting mode for video shooting at operation 504.

At operation 505, the controller 110 displays a video shooting progress bar in a predetermined area of the display 160 while shooting video on the display 160.

At operation 505, the controller 110 displays a plurality of icons indicating the plurality of sharing applications that are selected by the user at operation 502 and checks the video size supported by each of the plurality of sharing applications to arrange and display the plurality of icons at predetermined intervals (for example, in order of video size).

The controller 110 detects the setting of the ‘automatic storage for each sharing application’ option at operation 506 and sequentially and automatically stores a plurality of videos for the plurality of sharing applications at operation 507 while displaying a change in size of the shot video corresponding to video shooting time during video shooting on the video shooting progress bar.

At operation 507, each time the indication of the change in video size arrives at each of the plurality of icons that are sequentially arranged on the video shooting progress bar, the controller 110 stores the video that has been shot to the time the indication of the change in video size arrives at a specific icon since the beginning of the video shooting as video for the sharing application corresponding to the specific icon.

In other words, at operation 507, the controller 110 checks the video size that has changed since the beginning of the video shooting and, if the changed video size matches with the video size supported by a sharing application corresponding to a first icon, the controller 110 stores video for the sharing application corresponding to the first icon, shifting the indication of the change in video size to the first icon on the video shooting progress bar.

After the video for the sharing application corresponding to the first icon is stored, if the changed video size matches with a video size supported by a sharing application corresponding to a second icon among the plurality of icons arranged on the video shooting progress bar, the controller 110 stores video for the sharing application corresponding to the second icon, shifting the indication of the change in video size to the second icon on the video shooting progress bar.

In the same way, the controller 110 may automatically store a plurality of videos for a plurality of sharing applications during video shooting.

If an ‘end video shooting’ option is selected during the video shooting, the controller 110 detects the selection of the ‘end video shooting’ option at operation 508 and stores the video that has been shot to the time the video shooting is ended since the beginning of the video shooting at operation 509.

If a ‘store videos only for a plurality of sharing applications’ option is set, the controller 110 may store a plurality of videos only for the plurality of sharing applications and then automatically end the video shooting.

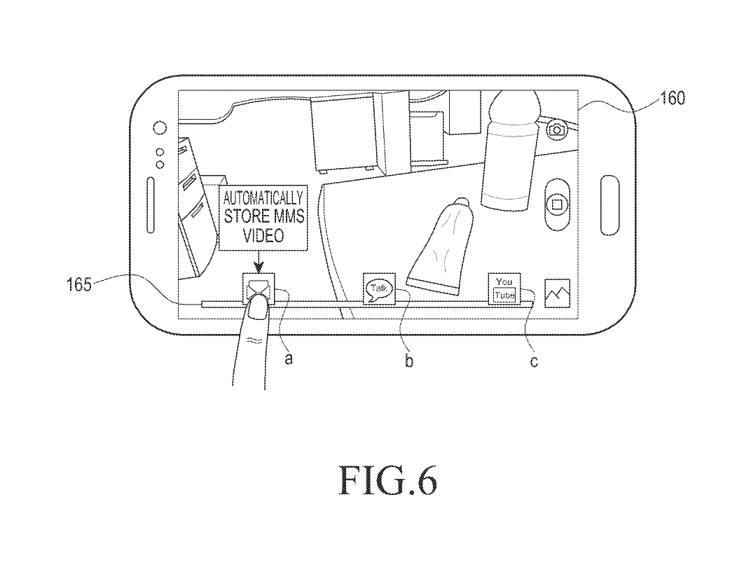

FIG. 6 illustrates a video shooting operation in a terminal according to a third embodiment of the present disclosure.

Referring to FIG. 6, if a specific icon ‘a’ is set while a plurality of icons ‘a’, ‘b’ and ‘c’ indicating their associated sharing applications (for example, Messaging, KaKao Talk™ and YouTube™) selected by the user are displayed in a predetermined area (for example, a lower area) of the display 160 in the video shooting mode during video shooting as illustrated in FIG. 2B, video for the ‘Messaging’ sharing application corresponding to the specific icon ‘a’ may be stored.

As illustrated in FIG. 6, a change in video size corresponding to video shooting time is displayed on the video shooting progress bar 165 during video shooting in the video shooting mode. If a specific icon ‘a’ among the plurality of icons ‘a’, ‘b’ and ‘c’ arranged on the video shooting progress bar 165 is selected by the user and an indication of the change in size of the shot video arrives at the specific icon ‘a’ arranged on the video shooting progress bar 165, the video that has been shot to the arrival time at the icon ‘a’ since the beginning of the video shooting is automatically stored as video for the ‘Messaging’ sharing application, and an indication indicating the automatic storage of the video for the ‘Messaging’ sharing application is displayed.

After the video for the ‘Messaging’ sharing application is automatically stored, if the indication of the change in video size corresponding to video shooting time arrives at the icon ‘b’ indicating a ‘KaKao Talk™’ sharing application that is arranged second on the video shooting progress bar 165, the video that has been shot to the arrival time at the icon ‘b’ since the beginning of the video shooting is automatically stored as video for the ‘KaKao Talk™’ sharing application and an indication indicating the automatic storage of the video for the ‘KaKao Talk™’ sharing application is displayed.

After the video for the ‘KaKao Talk™’ sharing application is automatically stored, if the indication of the change in video size corresponding to video shooting time arrives at the icon ‘c’ indicating a ‘YouTube™’ sharing application that is arranged third on the video shooting progress bar 165, the video that has been shot to the arrival time at the icon ‘c’ since the beginning of the video shooting is automatically stored as video for the ‘YouTube™’ sharing application, and an indication indicating the automatic storage of the video for the ‘YouTube™’ sharing application is displayed.

As described above, if a plurality of sharing applications are specified by the user during video shooting, a plurality of videos having different video sizes supported by the plurality of sharing applications may be automatically stored.

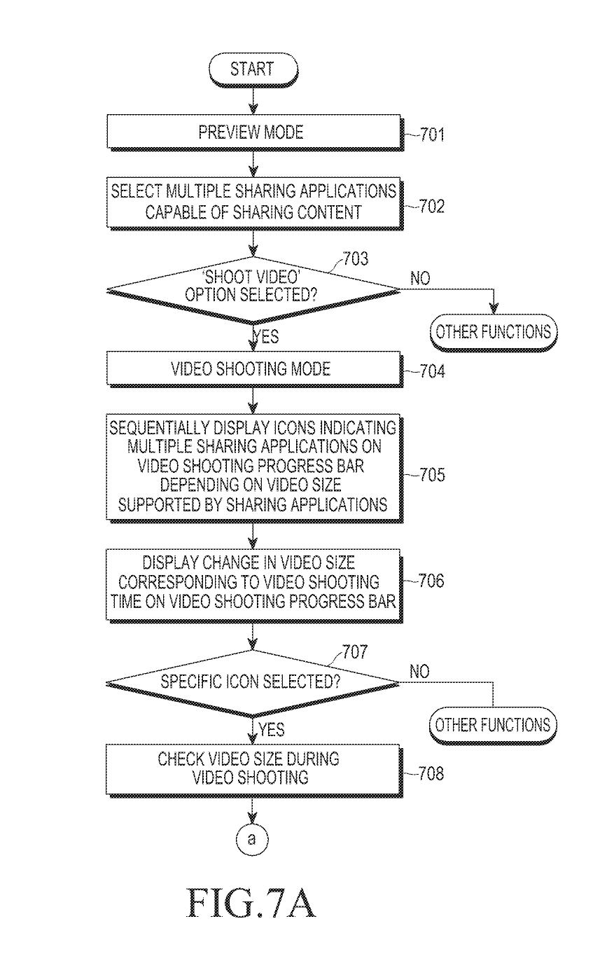

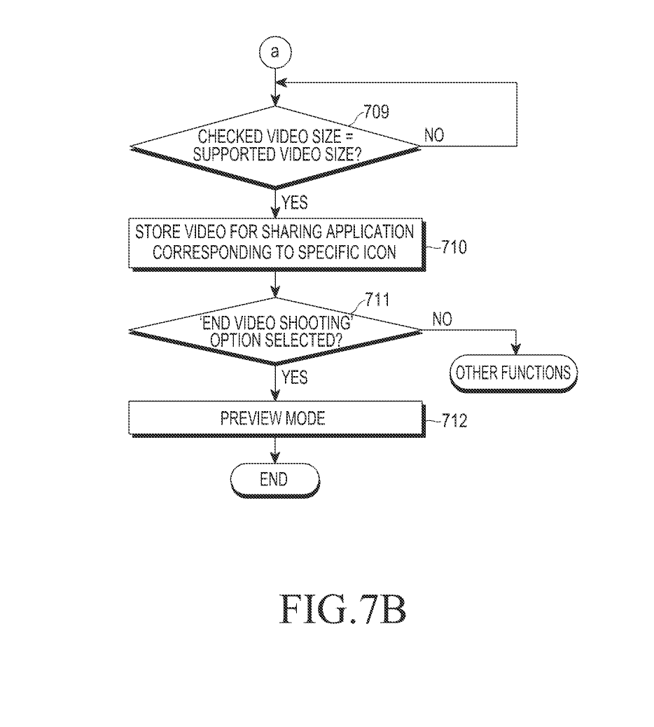

The operation in FIG. 6 will be described in detail below with reference to FIGS. 7A and 7B.

FIGS. 7A and 7B are flowcharts illustrating a video shooting process in a terminal according to the third embodiment of the present disclosure.

This video shooting process will be described in detail with reference to FIGS. 1, 7A and 7B.

Referring to FIGS. 7A and 7B, at operation 701, if a ‘view types of sharing applications’ option is selected in a preview mode, the controller 110 displays the types of sharing applications. If a ‘shoot video’ option is selected after a predetermined number of sharing applications are selected at operation 702 while displaying the types of sharing applications, the controller 110 detects the selection of the ‘shoot video’ option at operation 703 and switches to the video shooting mode for video shooting at operation 704.

At operation 705, the controller 110 displays a video shooting progress bar in a predetermined area of the display 160 while shooting video on the display 160 in the video shooting mode.

At operation 705, the controller 110 displays, on the video shooting progress bar, a plurality of icons indicating the plurality of sharing applications, which are selected by the user at operation 702, and checks the video size supported by each of the plurality of sharing applications to arrange and display the plurality of icons at predetermined intervals (for example, in order of video size).

At operation 706, as the video shooting is performed, the controller 110 displays a change in size of video being shot, which corresponds to video shooting time, on the video shooting progress bar on which the plurality of icons indicating the plurality of associated sharing applications are arranged at predetermined intervals.

If a specific icon among the plurality of icons arranged on the video shooting progress bar is selected, the controller 110 detects the selection of a specific icon at operation 707 and checks a change in video size corresponding to video shooting time during the video shooting at operation 708.

During the video shooting, if the size of the video being shot matches with a video size supported by a sharing application corresponding to the specific icon, the controller 110 detects the match of the video size at operation 709 and stores the video that has been shot to the time the indication indicating a change in video size arrives at the specific icon since the beginning of the video shooting as video for the sharing application corresponding to the specific icon at operation 710.

At operation 710, the controller 110 checks the size of the video that has changed since the beginning of the video shooting and, if the changed video size matches with the video size supported by a sharing application corresponding to the specific icon among the plurality of icons, the controller 110 stores video for the sharing application corresponding to the specific icon and shifts the indication of the change in video size to the specific icon on the video shooting progress bar.

If an ‘end video shooting’ option is selected during the video shooting, the controller 110 detects the selection of the ‘end video shooting’ option at operation 711 and stores the video that has been shot to the time the video shooting is ended since the beginning of the video shooting at operation 712.

If a ‘store videos only for a specific sharing application’ option is set, the controller 110 may store videos only for the specific sharing application and then automatically end the video shooting.

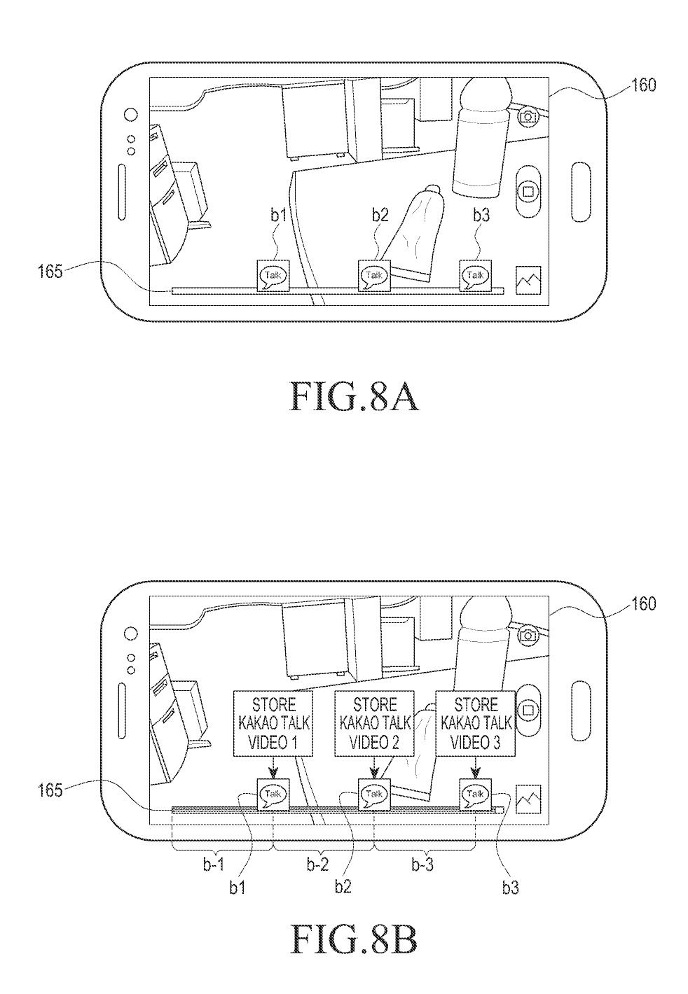

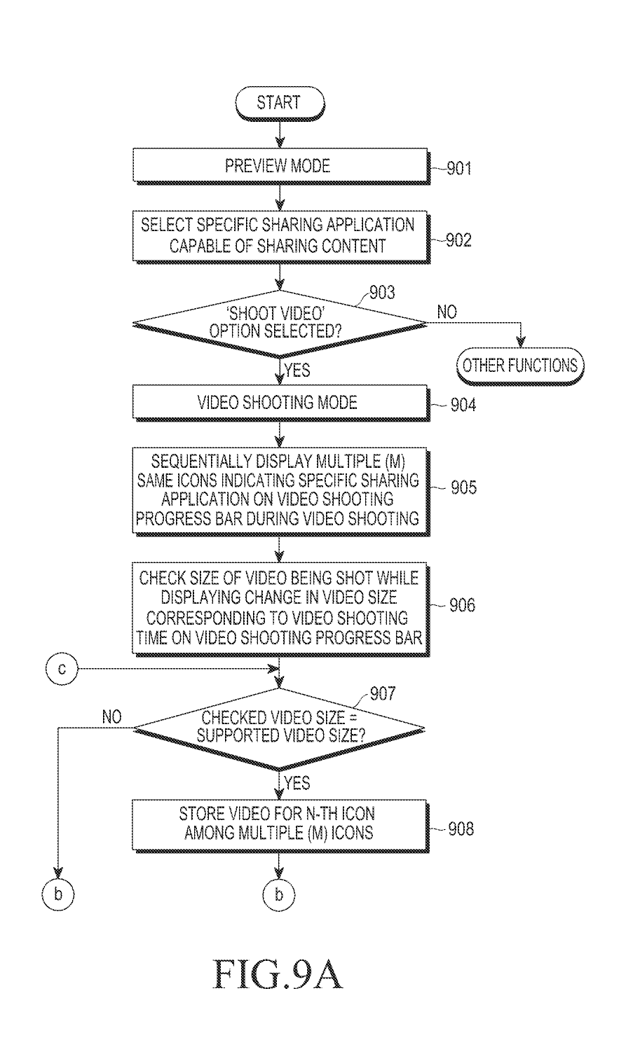

FIGS. 8A and 8B illustrate a video shooting operation in a terminal according to a fourth embodiment of the present disclosure.

Referring to FIG. 8A, during a video shooting mode in which video is being shot, a video shooting progress bar 165 is displayed in a predetermined area (for example, a lower area) of the display 160 with a plurality of same icons b1 to b3 indicating a single specific sharing application (for example, KaKao Talk™), which are selected by the user, that are arranged on the video shooting progress bar 165 at predetermined intervals.

In the case of FIG. 8A, if the user selects only a single specific sharing application to be displayed in the video shooting mode, a predetermined number of predetermined same icons may be arranged on the video shooting progress bar at predetermined intervals, or a predetermined number of same icons selected by the user may be arranged on the video shooting progress bar at predetermined intervals.

As illustrated in FIG. 8B, a change in video size corresponding to video shooting time is displayed on the video shooting progress bar 165 during video shooting in the video shooting mode. If an indication of the change in size of the shot video arrives at a first icon b1 that is arranged first on the video shooting progress bar 165, the video that has been shot to the arrival time b-1 at the first icon b1 since the beginning of the video shooting is automatically stored as a first video for the first icon b1 and an indication indicating the automatic storage of the first video for the first icon b1 is displayed.

After the first video for the first icon b1 is automatically stored, if an indication of the change in video size corresponding to video shooting time arrives at the second icon b2 on the video shooting progress bar 165, the video that has been shot to the arrival time b-2 since the beginning of the shooting of the video, the size of which has been checked since the storage of the first video for the first icon b1, is automatically stored as a second video for the second icon b2 and an indication indicating the automatic storage of the second video for the second icon b2 is displayed.

After the second video for the second icon b2 is automatically stored, if an indication of the change in video size corresponding to video shooting time arrives at the third icon b3 on the video shooting progress bar 165, the video that has been shot to the arrival time b-3 since the beginning of the shooting of the video, the size of which has been newly checked since the storage of the second video for the second icon b2, is automatically stored as a third video for the third icon b3 and an indication indicating the automatic storage of the third video for the third icon b3 is displayed.

Therefore, as described above, a plurality of videos having different video sizes supported by one specific sharing application may be separately stored in order of shooting time during video shooting such that consecutive video comprised of the plurality of videos may be provided.

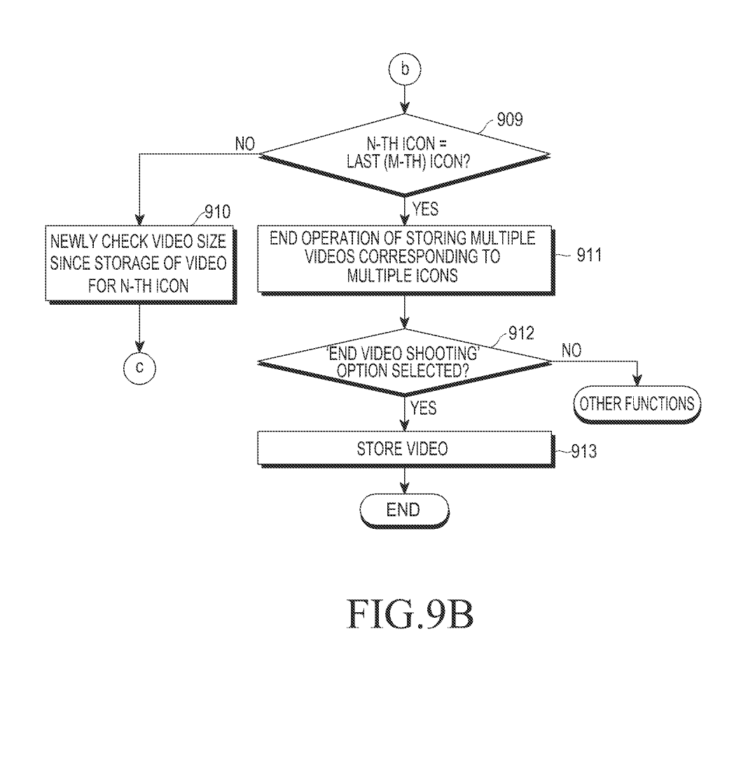

The operation in FIGS. 8A and 8B will be described in detail with reference to FIGS. 9A and 9B.

FIGS. 9A and 9B are flowcharts illustrating a video shooting process in a terminal according to the fourth embodiment of the present disclosure.

This video shooting process will be described in detail with reference to FIGS. 1, 9A and 9B.

Referring to FIGS. 9A and 9B, at operation 901, if a ‘view types of sharing applications’ option is selected in a preview mode, the controller 110 displays the types of sharing applications. If a ‘shoot video’ option is selected after one specific sharing application is selected at operation 902, the controller 110 detects the selection of the ‘shoot video’ option at operation 903 and switches to the video shooting mode for video shooting at operation 904.

At operation 905, the controller 110 displays a video shooting progress bar in a predetermined area of the display 160 while shooting video on the display 160 in the video shooting mode.

At operation 905, the controller 110 arranges and displays a plurality of, for example, M same icons indicating a specific sharing application selected by the user at operation 902 on the video shooting progress bar at predetermined intervals. The number of same icons displayed on the video shooting progress bar may be determined in advance or may be selected by the user.

At operation 906, the controller 110 checks the size of video being shot while displaying a change in video size corresponding to video shooting time on the video shooting progress bar.

If the checked video size matches with a video size supported by the specific sharing application, the controller 110 detects the match of the video size at operation 907 and stores video for a first icon that is arranged first on the video shooting progress bar at operation 908. At this time, an indication of the change in video size arrives at the first icon on the video shooting progress bar.

If it is determined at operation 909 that the first icon is not the last icon (for example, not an M-th icon), the controller 110 newly checks a video size since the storage of the video for the first icon, at operation.

If the newly checked video size matches with the video size supported by the specific sharing application, the controller 110 detects the match of the video size at operation 907, and stores video for a second icon that is arranged second on the video shooting progress bar, among the plurality of, for example, M substantially identical icons, at operation 908. At this moment, an indication of the change in video size arrives at the second icon on the video shooting progress bar.

If it is determined at operation 909 that the second icon is not the last icon (for example, not an M-th icon), the controller 110 newly checks a video size since the storage of the video for the second icon at operation 910.

After storing the video at operation 908, video for an icon that is arranged N-th on the video shooting progress bar, while repeatedly performing at operations 907 to 910, if the N-th icon is the similar to the last icon (for example, M-th icon), the controller 110 detects the degree of sameness (i.e., equivalence) of the icons at operation 909 and ends the operation of storing the plurality of videos for the specific sharing application to correspond to the plurality of icons at operation 911.

Through this operation, for one specific sharing application supporting a plurality of different video sizes, a plurality of videos having different video sizes may be separately provided in order of shooting time.

If an ‘end video shooting’ option is selected during the video shooting, the controller 110 detects the selection of the ‘end video shooting’ option at operation 912 and stores the video that has been shot to the time the video shooting is ended since the beginning of the video shooting at operation 913.

If a ‘store videos corresponding only to a plurality of icons’ option is set, the controller 110 may automatically end the video shooting after storing a plurality of videos only for the plurality of icons.

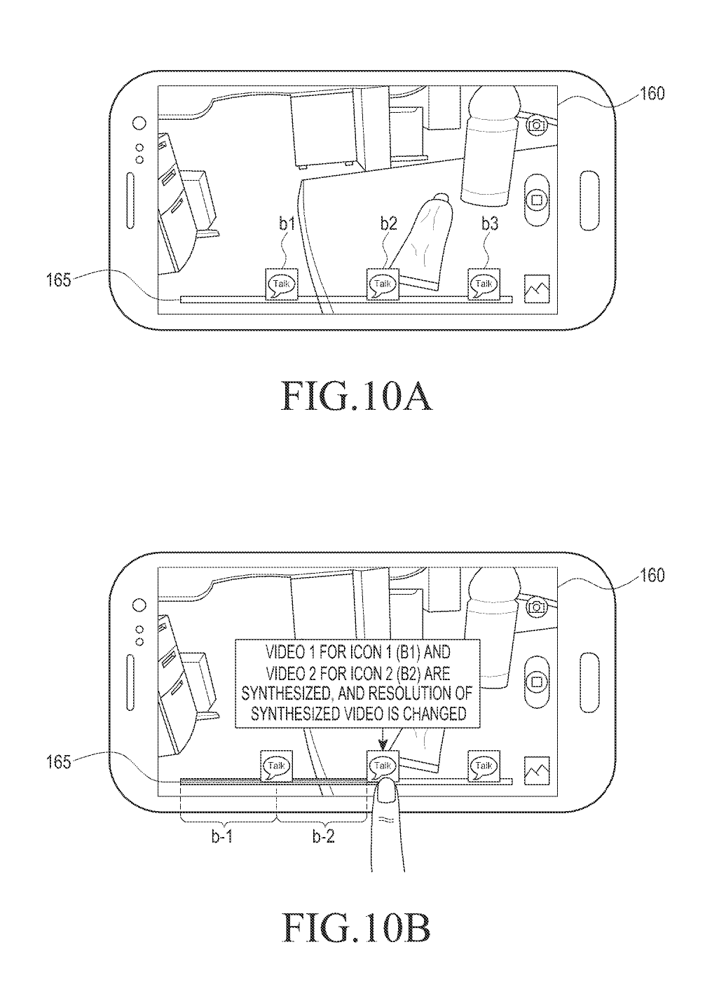

FIGS. 10A and 10B illustrate a video shooting operation in a terminal according to a fifth embodiment of the present disclosure.

Referring to FIG. 10A, a video shooting progress bar 165 is displayed in a predetermined area (for example, a lower area) of the display 160 that displays videos being shot in the video shooting mode, and a plurality of same icons b1 to b3 indicating a single specific sharing application (for example, KaKao Talk™) selected by the user are arranged on the video shooting progress bar 165 at predetermined intervals.

As illustrated in FIG. 10A, if the user selects only a single specific sharing application to be displayed in the video shooting mode, a predetermined number of predetermined same icons may be arranged on the video shooting progress bar at predetermined intervals, or a predetermined number of same icons selected by the user may be arranged on the video shooting progress bar at predetermined intervals.

As illustrated in FIG. 10B, a change in video size corresponding to video shooting time is displayed on the video shooting progress bar 165 during video shooting in the video shooting mode. If a video synthesis gesture occurs on a second icon b2, which is a specific icon among a plurality of same icons b1 to b3 displayed on the video shooting progress bar 165, and an indication of a change in video size arrives at a first icon b1 that is arranged first on the video shooting progress bar 165, the video that has been shot to the arrival time b-1 at the first icon b1 since the beginning of the video shooting is stored as first video for the first icon b1. The video synthesis gesture may be a long touch on a specific icon, or a drag operation from a first icon to a specific icon.

After the first video for the first icon b1 is automatically stored, if the indication of a change in video size corresponding to video shooting time arrives at the second icon b2 on the video shooting progress bar 165, the video that has been shot to the arrival time b-2 at the second icon b2 since the beginning of the shooting of the video, the size of which has been newly checked since the storage of the first video for the first icon b1, is stored as second video for the second icon b2.

After the first video for the first icon b1 and the second video for the second icon b2 are synthesized, the controller 110 reduces a resolution so that a size of the synthesized video may match with a video size supported by the specific sharing application, generating a resolution-reduced video as one video for the specific sharing application. If one new video is generated, an indication may be displayed to inform the use of the synthesis of the first video for the first icon b1 and the second video for the second icon b2 and of the change in resolution.

When a video synthesis gesture occurs on a specific icon, even though video for the specific icon and the video for at least one icon arranged ahead of the specific icon are synthesized and a resolution of the synthesized video is reduced, the size of the synthesized video may not match with the video size supported by the specific sharing application. In this case, an indication may be displayed to inform the user of impossibility of the synthesis.

Therefore, during the video shooting, by synthesizing two videos during the video shooting, each of which has the same video size as a video size supported by one specific sharing application and are classified in order of shooting time, and by reducing a resolution of the synthesized video, one video for the specific sharing application may be provided.

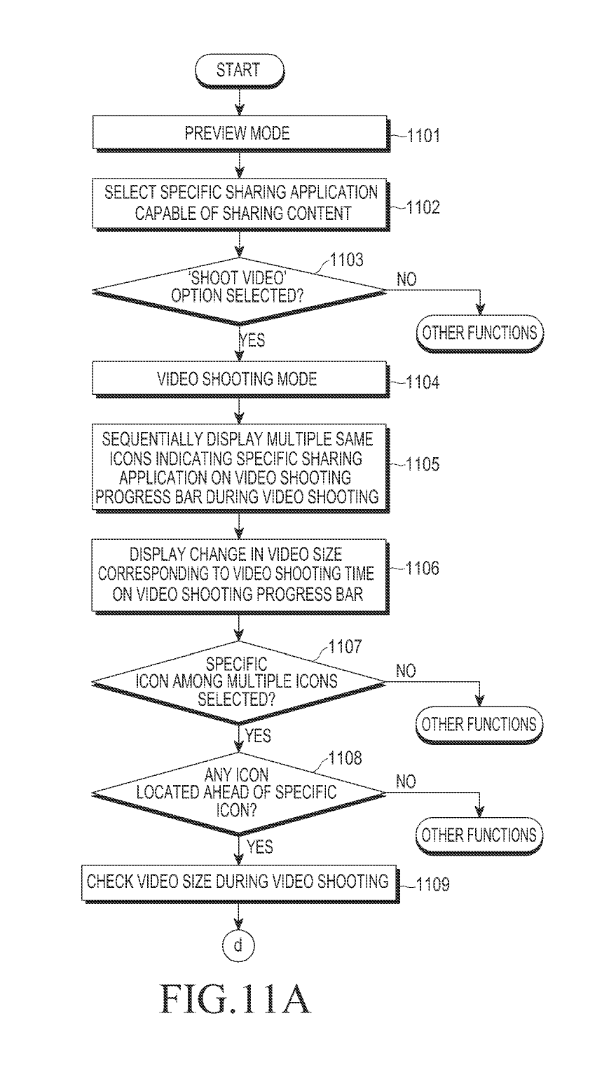

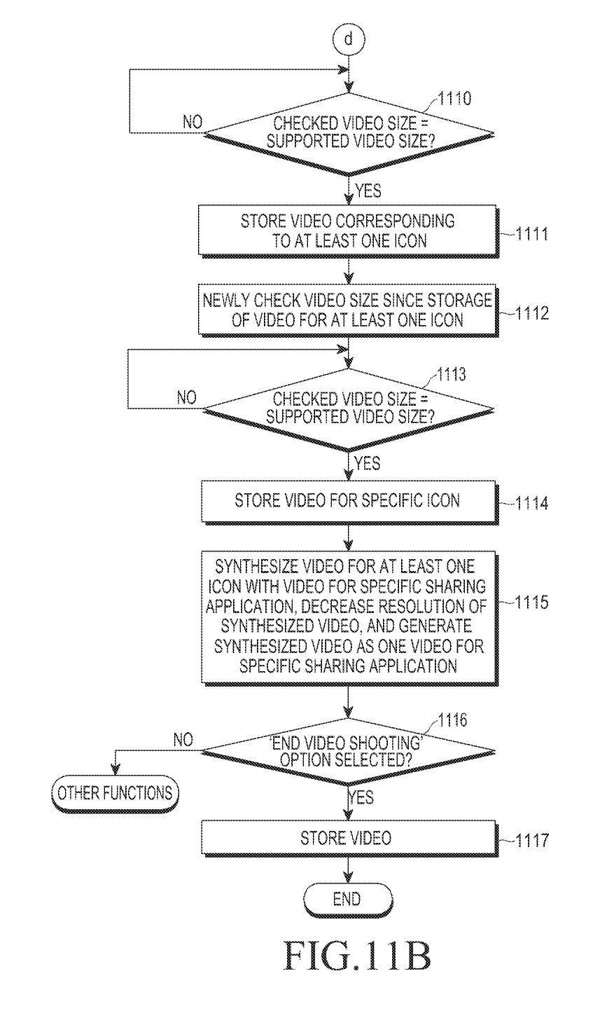

The operation in FIGS. 10A and 10B will be described in detail below with reference to FIGS. 11A and 11B.

FIGS. 11A and 11B are flowcharts illustrating a video shooting process in a terminal according to the fifth embodiment of the present disclosure.

The video shooting process will be described in detail with reference to FIGS. 1, 11A and 11B.

Referring to FIGS. 11A and 11B, at operation 1101, if a ‘view types of sharing applications’ option is selected in a preview mode, the controller 110 displays the types of sharing applications. If a ‘shoot video’ option is selected after one specific sharing application is selected at operation 1102 while displaying the types of sharing applications, the controller 110 detects the selection of the ‘shoot video’ option at operation 1103 and switches to the video shooting mode for video shooting at operation 1104.

At operation 1105, the controller 110 displays a video shooting progress bar in a predetermined area of the display 160 while shooting video on the display 160 in the video shooting mode.

At operation 1105, the controller 110 arranges and displays, on the video shooting bar at predetermined intervals, a plurality of same icons indicating a specific sharing application that was selected by the user at operation 1102. The number of same icons displayed on the video shooting progress bar may be determined in advance or may be selected by the user.

At operation 1106, during video shooting, the controller 110 displays a change in video size corresponding to video shooting time on the video shooting progress bar.

If a specific icon among the plurality of same icons is selected while displaying the change in size of the video being shot, the controller 110 detects the selection of the specific icon at operation 1107 and determines at operation 1108 whether there is at least one icon located ahead of the specific icon on the video shooting progress bar.

The selection of a specific icon may be a long touch or a drag operation for video synthesis. If at least one icon exists ahead of the selected specific icon on the video shooting progress bar, the selection of the specific icon may be determined as performing a video synthesis operation.

If there is at least one icon located ahead of the specific icon on the video shooting progress bar, the controller 110 detects the presence of at least one icon located ahead of the specific icon at operation 1108, the controller 110 checks a size of the video being shot during the video shooting at operation 1109.

If the checked video size matches with a video size supported by the specific sharing application, the controller 110 detects the match of the video size at operation 1110 and stores the video that has been shot to the time the video sizes match each other since the beginning of the video shooting as video for the at least one icon, at operation 1111.

In a case where there are two or more icons arranged ahead of the specific icon on the video shooting progress bar, if a size of the video being shot in order of the icon arranged on the video shooting progress bar matches with a video size supported by the specific sharing application, the controller 110 stores the video that has been shot to the time the video sizes match each other since the beginning of the video shooting as video for a first icon. The controller 110 newly checks a video size since the storage of the video for the first icon. If the newly checked video size matches with a video size supported by the specific sharing application, the controller 110 stores the video that has been shot to the time the video sizes match each other since the beginning of the video whose size is newlywed checked as video for a second icon. Through this operation, the controller 110 may store videos for two or more icons arranged ahead of the specific icon.

After storing video for the at least one icon, the controller 110 newly checks a video size at operation 1112.

If the newly checked video size matches with a video size supported by the specific sharing application, the controller 110 detects the match of the video size at operation 1113 and stores the video that has been shot to the time the video sizes match each other since the beginning of the video shooting as video for the specific icon at operation 1114.

At operation 1115, the controller 110 synthesizes the video stored at operation 1111, and the video stored at operation 1114 and reduces a resolution of the synthesized video so that the size of the synthesized video may correspond to the video size supported by the specific sharing application.

After synthesizing at last two videos and reducing a resolution of the synthesized video at operation 1115, the controller 110 generates and stores the resolution-reduced video as one video for the specific sharing application.

If an ‘end video shooting’ option is selected during the video shooting, the controller 110 detects the selection of the ‘end video shooting’ option at operation 1116 and stores the video that has been shot to the time the video shooting ended at operation 1117.

If a ‘synthesize videos corresponding to at least two icons and store synthesized video as one video’ option is set, the controller 110 may synthesize videos corresponding to the least two icons, store the synthesized video as one video, and then automatically end the video shooting.

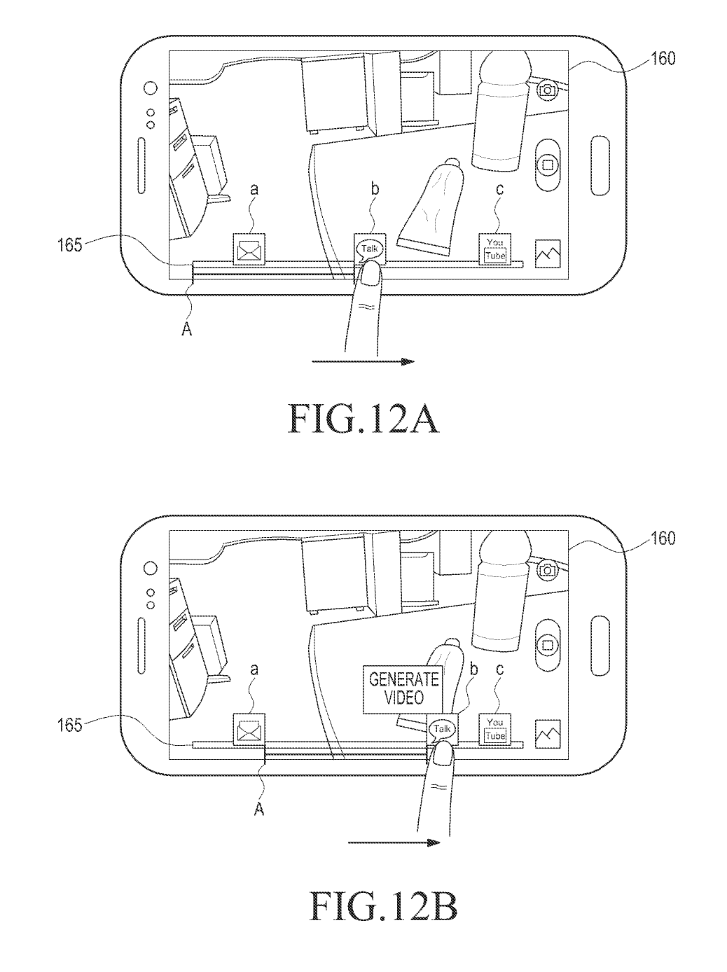

FIGS. 12A and 12B illustrate a video shooting operation in a terminal according to a sixth embodiment of the present disclosure.

Referring to FIG. 12A, a video shooting progress bar 165 is displayed in a predetermined area (for example, a lower area) of the display 160 during video shooting in the video shooting mode and a plurality of icons ‘a’, ‘b’ and ‘c’ indicating their associated sharing applications (for example, Messaging, KaKao Talk™ and YouTube™) selected by the user are sequentially displayed on the video shooting progress bar 165 based on the video size (for example, in order of video size) supported by each of the selected sharing applications.

If the user desires to change a video shooting period for a specific sharing application, the user may touch and shift (or drag) a specific icon ‘b’ among the plurality of icons ‘a’, ‘b’ and ‘c’ in a desired direction while touching the display 160, as illustrated in FIG. 12B.

Referring to FIG. 12B, if the user shifts a specific icon ‘b’ to the desired position on the video shooting progress bar 165 by a touch-and-drag operation, a starting position ‘A’ indicating a change in video size on the video shooting progress bar 165 is also shifted to correspond to the shift of the specific icon b.

In this way, by shifting an icon indicating a sharing application, the user may select or determine a video shooting period for the sharing application.

The videos for sharing applications, which are generated through the operations described with reference to FIGS. 2A to 12B, are generated in associated folders that are classified based on the type of the sharing applications. Therefore, if a ‘view video in a folder of videos’ option is selected or if a ‘view video’ option is selected to transfer or share videos by running a sharing application, video files for the sharing application, which are stored in the folders that are classified based on the type of sharing applications, may be displayed.

Alternatively, if a ‘view video in a folder’ option is selected or if a ‘view video’ option is selected to transfer or share videos by running a sharing application, video files may be displayed, showing an indication indicating the type of sharing application.

The description according to FIGS. 2A to 12B may be applied not only in the video shooting mode, but also during video playback in a video-editing mode.

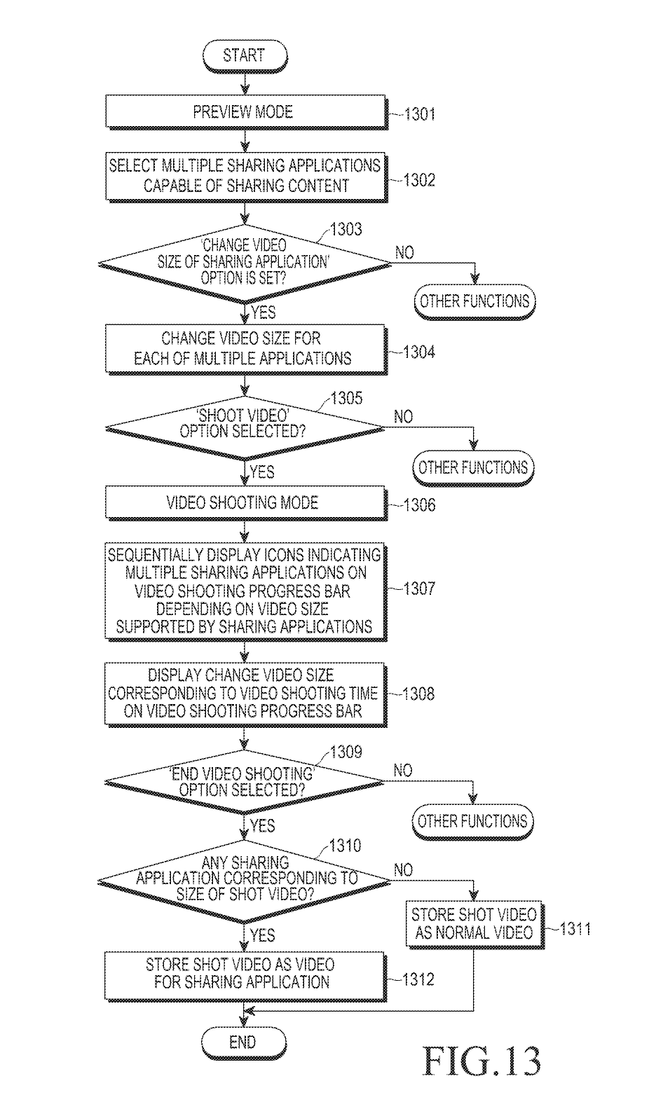

FIG. 13 is a flowchart illustrating a video shooting process in a terminal according to a seventh embodiment of the present disclosure.

This video shooting process will be described in detail with reference to FIGS. 1 and 13.

Referring to FIG. 13, at operation 1301, if a ‘view types of sharing applications’ option is selected in a preview mode, the controller 110 displays the types of sharing applications. If a ‘change a video size of a sharing application’ option is selected after a predetermined number sharing applications are selected at operation 1302 while displaying the types of sharing applications, the controller 110 detects the selection of the ‘change a video size of a sharing application’ option at operation 1303, and switches to a video size change mode for sharing applications at operation 1304. That is, in the video size change mode for the sharing applications, if a video size for each of the predetermined number of sharing applications selected at operation 1302 is changed by the user, the controller 110 detects the change in video size at operation 1303, and sets or changes a video size supported by each of the sharing applications to the video size set by the user at operation 1304. At operation 1304, the video size for each of the predetermined number of sharing applications, which is changed by the user, may be smaller than the original video size supported by each of the sharing applications. Therefore, the video size supported by the sharing application may be changed to a smaller video size by the user.

If a ‘shoot video’ option is selected after the video size for each of the predetermined number of sharing applications is changed, the controller 110 detects the selection of the ‘shoot video’ option at operation 1305, and switches to the video shooting mode for video shooting at operation 1306.

At operation 1307, the controller 110 displays a video shooting progress bar in a predetermined area of the display 160 while shooting video on the display 160 in the video shooting mode.

At operation 1307, the controller 110 displays, on the video shooting progress bar, a plurality of icons indicating the plurality of sharing applications selected by the user at operation 1302 and checks a video size set for each of the plurality of sharing applications to arrange and display the plurality of icons at predetermined intervals in the order of video size.

At operation 1308, as the video shooting is performed, the controller 110 displays a change in video size corresponding to video shooting time on the video shooting progress bar on which the plurality of icons indicating the plurality of associated sharing applications are arranged at predetermined intervals.

If an ‘end video shooting’ option is selected during the video shooting, the controller 110 detects the selection of the ‘end video shooting’ option at operation 1309 and determines whether there is a specific sharing application supporting the video size corresponding to the period from the beginning of the video till the time the video shooting is ended at operation 1310.

If there is a specific sharing application supporting the video size corresponding to the period from the beginning of the video until the time the video shooting is ended, the controller 110 detects the presence of the specific sharing application at operation 1310 and stores the video that has been shot to the time the video shooting is ended since the beginning of the video in the memory 130 as video for the specific sharing application at operation 1312.

Referring back to operation 1310, if there is no specific sharing application supporting the video size corresponding to the period from the beginning of the video until the time the video shooting is ended, the controller 110 detects the absence of the specific sharing application at operation 1310 and stores the video that has been shot to the time the video shooting is ended since the beginning of the video in the memory 130 as a normal video, at operation 1311.

Various embodiments of the present disclosure may be implemented as computer-readable codes in a non-transitory computer-readable recording media. The computer-readable recording media may include all suitable recording devices that store computer-readable data. Typical examples of the recording media may include Read Only Memory (ROM), Random Access Memory (RAM), optical discs, magnetic tapes, floppy discs, hard discs, non-volatile memories and the like.

As is apparent from the foregoing description, the video shooting apparatus and method proposed by various embodiments of the present disclosure may display types of supportable sharing applications based on the video size during video shooting, thereby allowing the user to shoot video complying with his/her intention and preventing the user from editing or re-shooting the video.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An apparatus for shooting video in a terminal, the apparatus comprising:
a display configured to sequentially display on a video shooting progress bar a plurality of indications indicating a plurality of associated sharing applications capable of sharing content based on a video size supported by each of the plurality of sharing applications, in a video shooting mode; and
a controller configured to display a change in a video size corresponding to video shooting time on the video shooting progress bar in the video shooting mode, thereby controlling the display to sequentially display types of sharing applications capable of supporting the video size changed during video shooting.

2. The apparatus of claim 1, wherein, after the video shooting is ended, if there is a sharing application supporting a video size at the time the video shooting is ended, among the plurality of sharing applications corresponding to the plurality of indications displayed on the video shooting progress bar, the controller is configured to store video that has been shot to the time the video shooting is ended as video for the sharing application.

3. The apparatus of claim 1, wherein, while displaying the change in the video size, the controller is configured to sequentially store a plurality of videos for the plurality of associated sharing applications corresponding to the plurality of indications that are displayed on the video shooting progress bar based on the change in the video size.

4. The apparatus of claim 1, wherein, if a specific indication is selected on the video shooting progress bar, while displaying the change in video size and if the video size matches with a video size supported by a sharing application corresponding to the specific indication, the controller is configured to store a video that has been shot to the time the video sizes match each other from the beginning of the video as video for the sharing application corresponding to the specific indication.

5. The apparatus of claim 1, wherein the controller is further configured to:
check a size of video being shot while sequentially displaying a plurality of same indications indicating one specific sharing application on the video shooting progress bar and displaying a change in video size corresponding to a video shooting time on the video shooting progress bar;
if the checked size of the video matches with a video size supported by the specific sharing application, store video that has been shot to the time the video sizes match each other from the beginning of the video as video for a first indication among the plurality of same indications;
newly check a video size since the storage of the video for the first indication;
if the newly checked video size matches with a video size supported by the specific sharing application, store video that has been shot to the time the video sizes match each other from the beginning of the video whose size is newly checked as video for a second indication located after the first indication; and
after storing the video for the second indication, store a plurality of videos corresponding to the specific sharing application while newly checking a video size.

6. The apparatus of claim 1, wherein the controller is further configured to:
if a specific indication among a plurality of same indications is selected while sequentially displaying the plurality of same indications indicating one specific sharing application on the video shooting progress bar and displaying a change in video size corresponding to video shooting time on the video shooting progress bar, determine whether there is at least one indication that is located ahead of the specific indication on the video shooting progress bar;
if there is at least one indication that is located ahead of the specific indication on the video shooting progress bar, check a size of video being shot;
if the checked size of video matches with a video size supported by the specific sharing application, store video that has been shot to the time the video sizes match each other from the beginning of the video as video for the at least one indication;
newly check a video size since the storage of the video for the at least one indication;
if the newly checked video size matches with a video size supported by the specific sharing application, store video that has been shot to the time the video sizes match each other from the beginning of the video whose size is newly checked as video for the specific indication; and
synthesize the video for the at least one indication with the video for the specific indication, reduce a resolution of the synthesized video, and generate the resolution-reduced video.

7. The apparatus of claim 6, wherein the controller is further configured to:
if a plurality of indications are located ahead of the specific indication on the video shooting progress bar and the checked video size matches with the video size supported by the specific sharing application, store video that has been shot to the time the video sizes match each other from the beginning of the video, as video for a first indication among the plurality of indications;
newly check a video size since the storage of the video for the first indication;
if the newly checked video size matches with the video size supported by the specific sharing application, store video that has been shot to the time the video sizes match each other from the beginning of the video whose size is newly checked as video for an indication located behind the first indication; and
after storing the video for the indication located after the first indication, store a plurality of videos for the plurality of indications located ahead of the specific indication while newly checking a video size.

8. The apparatus of claim 1, wherein, if a position of a specific indication among the plurality of indications is adjusted on the video shooting progress bar while displaying a change in video size corresponding to video shooting time on the video shooting progress bar on which the plurality of indications indicating the plurality of associated sharing applications are sequentially displayed, the controller is configured to change a storage period of the video for a sharing application corresponding to the specific indication.

9. The apparatus of claim 1, wherein if a ‘view video’ option is selected, the controller is further configured to display a video file stored in a folder that is classified according to a type of the sharing application or to display an indication indicating the sharing application in a video file.

10. The apparatus of claim 1, wherein the controller is configured to sequentially display, on the video shooting progress bar the plurality of indications indicating the plurality of associated sharing applications capable of sharing content based on the video size which is changed by a user for each of the plurality of sharing applications, in the video shooting mode.

11. A method for shooting video in a terminal, the method comprising:
sequentially displaying on a video shooting progress bar a plurality of indications indicating a plurality of associated sharing applications capable of sharing content based on a video size supported by each of the plurality of sharing applications, in a video shooting mode; and
displaying a change in a video size corresponding to video shooting time on the video shooting progress bar in the video shooting mode, thereby sequentially displaying types of sharing applications capable of supporting the video size changed during video shooting.

12. The method of claim 11, further comprising:
after the video shooting is ended, determining whether there is a sharing application supporting a video size at the time the video shooting is ended, among the plurality of sharing applications corresponding to the plurality of indications displayed on the video shooting progress bar; and
if there is a sharing application supporting a video size at the time the video shooting is ended, storing video that has been shot to the time the video shooting is ended, as video for the sharing application.

13. The method of claim 11, further comprising:
while displaying the change in video size determining whether an ‘automatic storage for each sharing application’ option is set; and
if the ‘automatic storage for each sharing application’ option is set, sequentially storing a plurality of videos for the plurality of associated sharing applications corresponding to the plurality of indications, which are displayed on the video shooting progress bar based on the change in the video size.

14. The method of claim 11, further comprising:
if a specific indication is selected on the video shooting progress bar, while displaying the change in video size corresponding to video shooting time, checking a size of the video being shot; and
if the checked video size matches with a video size supported by a sharing application corresponding to the specific indication, storing video that has been shot to the time the video sizes match each other from the beginning of the video, as video for the sharing application corresponding to the specific indication.

15. The method of claim 11, further comprising:
sequentially displaying a plurality of same indications indicating one specific sharing application on the video shooting progress bar;
checking a size of video being shot while displaying a change in video size corresponding to a video shooting time on the video shooting progress bar;
if the checked size of the video matches with a video size supported by the specific sharing application, storing video that has been shot to the time the video sizes match each other from the beginning of the video as video for a first indication among the plurality of same indications;
newly checking a video size since the storage of the video for the first indication;
if the newly checked video size matches with a video size supported by the specific sharing application, storing video that has been shot to the time the video sizes match each other from the beginning of the video whose size is newly checked, as video for a second indication located after the first indication; and
after storing the video for the second indication, storing a plurality of videos corresponding to the specific sharing application while newly checking a video size.

16. The method of claim 11, further comprising:
sequentially displaying a plurality of same indications indicating one specific sharing application on the video shooting progress bar;
if a specific indication among the plurality of same indications is selected while displaying a change in video size corresponding to video shooting time on the video shooting progress bar, determining whether there is at least one indication that is located ahead of the specific indication on the video shooting progress bar;
if there is at least one indication that is located ahead of the specific indication on the video shooting progress bar, checking a size of video being shot;
if the checked size of video matches with a video size supported by the specific sharing application, storing video that has been shot to the time the video sizes match each other from the beginning of the video as video for the at least one indication;
newly checking a video size since the storage of the video for the at least one indication;
if the newly checked video size matches with a video size supported by the specific sharing application, storing video that has been shot to the time the video sizes match each other from the beginning of the video whose size is newly checked, as video for the specific indication; and
synthesizing the video for the at least one indication with the video for the specific indication, reducing a resolution of the synthesized video, and generating the resolution-reduced video.

17. The method of claim 16, wherein the storing of the shot video as video for the at least one indication comprises:
if a plurality of indications are located ahead of the specific indication on the video shooting progress bar and the checked video size matches with the video size supported by the specific sharing application, storing video that has been shot to the time the video sizes match each other from the beginning of the video, as video for a first indication among the plurality of indications;
newly checking a video size since the storage of the video for the first indication;
if the newly checked video size matches with the video size supported by the specific sharing application, storing video that has been shot to the time the video sizes match each other from the beginning of the video whose size is newly checked, as video for an indication located behind the first indication; and
after storing the video for the indication located after the first indication, storing a plurality of videos for the plurality of indications located ahead of the specific indication while newly checking a video size.

18. The method of claim 11, further comprising, if a position of a specific indication among the plurality of indications is adjusted on the video shooting progress bar while displaying a change in video size corresponding to video shooting time on the video shooting progress bar on which the plurality of indications indicating the plurality of associated sharing applications are sequentially displayed, changing a storage period of the video for a sharing application corresponding to the specific indication.

19. The method of claim 11, further comprising, if a ‘view video’ option is selected, displaying a video file stored in a folder that is classified according to a type of the sharing application or displaying an indication indicating the sharing application in a video file.

20. The method of claim 11, further comprising, sequentially displaying on the video shooting progress bar the plurality of indications indicating the plurality of associated sharing applications capable of sharing content based on the video size which is changed by the user for each of the plurality of sharing applications, in the video shooting mode.
